(19) United States
(12) Patent Application Publication
(10) Pub. No.: US 2018/0183640 A1
(43) Pub. Date: Jun. 28, 2018

(54) SHORT RESOURCE REQUESTS

(71) Applicant: Intel IP Corporation, Santa Clara, CA (US)

(72) Inventors: Laurent Cariou, Portland, OR (US); Chittabrata Ghosh, Fremont, CA (US); Robert Stacey, Portland, OR (US)

(21) Appl. No.: 15/578,198

(22) PCT Filed: Jun. 28, 2016
(86) PCT No.: PCT/US2016/039788

§ 371 Date: Nov. 29, 2017

Related U.S. Application Data
(60) Provisional application No. 62/192,334, filed on Jul. 14, 2015.
(60) Provisional application No. 62/192,343, filed on Jul. 14, 2015.
(60) Provisional application No. 62/192,316, filed on Jul. 14, 2015.

(51) Int. Cl. H04L 27/26; H04L 5/00; H04W 72/04; H04B 7/0413; H04J 11/00; H04W 84/12

(52) U.S. Cl. CPC H04L 27/26; H04L 5/0007; H04W 84/12; H04B 7/0413; H04J 11/0023; H04W 72/0413

(57) ABSTRACT

This disclosure describes systems, methods, and apparatus, related to a short resource request. A device may identify one or more high efficiency long training (HE-LTF) fields received from at least one of one or more first devices. The device may determine one or more bits associated with the one or more HE-LTF fields. The device may determine an uplink orthogonal frequency division multiple access (OFDMA) request based at least in part on the one or more bits.

### CROSS-REFERENCE TO RELATED APPLICATIONS

This application claims the benefit of U.S. Provisional Application No. 62/192,343 filed Jul. 14, 2015, U.S. Provisional Application No. 62/192,334 filed Jul. 14, 2015, and U.S. Provisional Application No. 62/192,316 filed Jul. 14, 2015, the disclosures of which are incorporated herein by reference as if set forth in full.

### TECHNICAL FIELD

This disclosure generally relates to systems and methods for wireless communications and, more particularly, to short resource requests in wireless communications.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes orthogonal frequency division multiple access (OFDMA) in channel allocation.

### BRIEF DESCRIPTION OF THE DRAWINGS

FIG. 1 depicts a network diagram illustrating an example network environment of an illustrative short resource request system, in accordance with one or more example embodiments of the present disclosure.

FIG. 2 depicts an illustrative schematic diagram of a high efficiency long training (HE-LTF) field transmission on the uplink (UL), in accordance with one or more example embodiments of the present disclosure.

FIG. 3 depicts an illustrative schematic diagram of a short resource request system, in accordance with one or more example embodiments of the present disclosure.

FIG. 4A depicts an illustrative schematic diagram of a short resource request system, in accordance with one or more example embodiments of the present disclosure.

FIG. 4B depicts an illustrative schematic diagram of a short resource request system, in accordance with one or more example embodiments of the present disclosure.

FIG. 5A depicts a flow diagram of an illustrative process for a short resource request system, in accordance with one or more embodiments of the disclosure.

FIG. 5B depicts a flow diagram of an illustrative process for a short resource request system, in accordance with one or more embodiments of the disclosure.

FIG. 6 illustrates a functional diagram of an example communication station that may be suitable for use as a user device, in accordance with one or more example embodiments of the disclosure.

FIG. 7 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices for providing signaling to Wi-Fi devices in various Wi-Fi networks, including, but not limited to, IEEE 802.11ax (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A design target for HEW is to adopt methods to improve the efficiency of Wi-Fi, and specifically the efficiency in dense deployments of Wi-Fi devices, such as in malls, conference halls, etc. HEW may use orthogonal frequency division multiple access (OFDMA) techniques for channel access in the uplink and downlink directions. It is understood that the uplink direction is from a user device to an access point (AP), and the downlink direction is from an AP to one or more user devices. In the uplink direction, one or more user devices may be communicating with the AP and may be competing for channel access in a random channel access manner. In that case, the channel access in OFDMA may require coordination among the various user devices that may be competing to access the operating channel simultaneously. A trigger frame may consist of a preamble along with other signaling, such as resource allocation, to coordinate the uplink OFDMA operation. A trigger frame is simply a frame that contains a preamble and other fields that may be sent from an AP informing all user devices serviced by the AP that channel access is available.

Example embodiments of the present disclosure relate to systems, methods, and devices for a short resource request system that may utilize one or more consecutive high efficiency long training (HE-LTF) fields for a resource request mechanism.

User devices that want to send a resource request to an AP may code their multi-bit resource requests on multiple consecutive HE-LTF fields using their assigned or randomly selected resource block IDs (RBIDs). An AP may assign an RBID to a user device at the time the user device associates or communicates with the AP. For example, in order to code a bit equal to 1 on a specific slot, the user device may transmit the HE-LTF using its RBID. That is, the user device may utilize the RBID assigned to it in order to use a spatial stream for transmitting the HE-LTF field in order to indicate that a code bit is equal to 1 (or a YES answer). To code a bit equal to 0 (or a NO answer) on a specific slot, the user device may not transmit anything. That is, the spatial stream associated with the user device's RBID may be left empty in order to indicate a code bit equal to 0 (or a NO answer). On each RBID, the AP will collect the bits received on the different fields and will determine the resource request information.

In one embodiment, the short resource request system may utilize a time dimension aspect such that one or more consecutive HE-LTF fields may be used for a resource request mechanism. User devices that want to send a resource request to an AP may code their multi-bit resource requests on the multiple consecutive HE-LTF fields using their assigned and randomly selected resource block IDs (RBIDs). A user device that intends to transmit one or more resource requests using the HE-LTF field may transmit on consecutive HE-LTF fields in the time domain. For example, a user device may transmit on an HE-LTF field with the same assigned RBID.

In one embodiment, a user device may transmit on consecutive HE-LTF fields having different RBIDs assigned to the corresponding HE-LTF fields.

In one embodiment, a user device may transmit on consecutive HE-LTF fields with the assigned RBID on the first HE-LTF field and on the RBID equal to the assigned RBID plus a delta_N value modulo (max number of RBIDs) for the Nth HE-LTF field. Having consecutive HE-LTF fields based on the same or varied RBIDs may increase the reliability of the reception, especially when RBIDs may be from different resource units, which may avoid channel dips in frequency.

In one embodiment, a device may transmit on consecutive HE-LTF fields that may each be associated with a group of devices. That is, a first HE-LTF field may be transmitted in time over various resource units (RUs), RBIDs, and spatial streams (SSs), where the first HE-LTF field may be associated with devices 1-36, in the case of nine RUs. Further, a second HE-LTF field may be transmitted in time over various RUs, RBIDs, and SSs, where the second HE-LTF field may be associated with devices 37-72. Although, this example uses nine RUs and 72 devices, other numbers of RUs and devices may be utilized based on the communication channel frequency bandwidth being used.

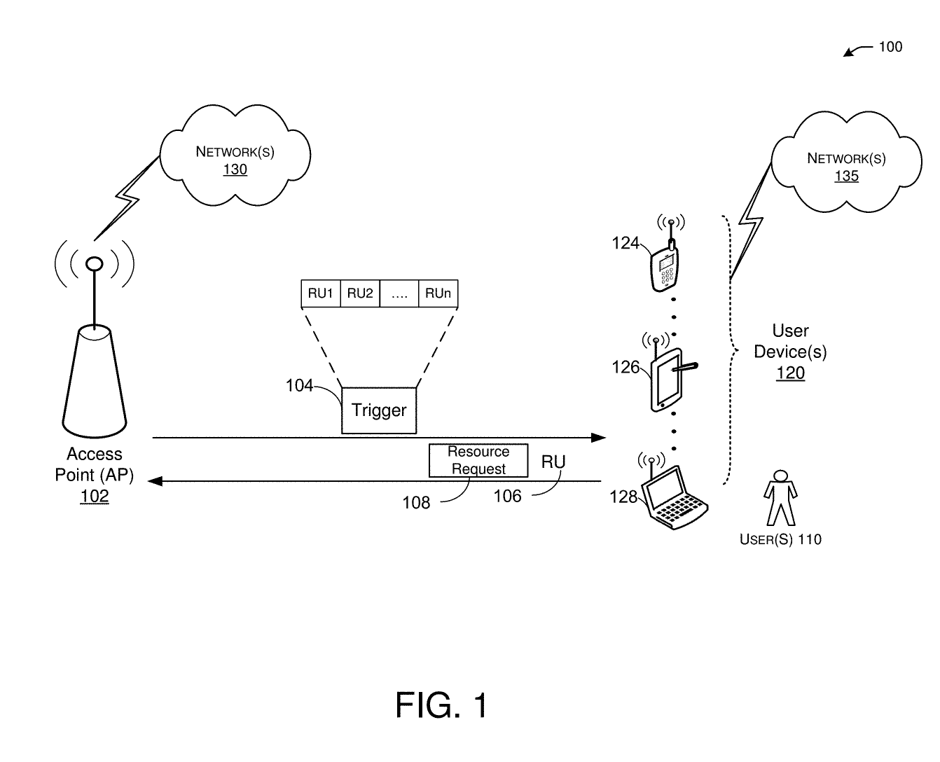

Referring to FIG. 1, there is shown a network diagram illustrating an example wireless network 100 for a short resource request system, according to some example embodiments of the present disclosure. Wireless network 100 may include one or more user devices 120 and one or more access point(s) (AP) 102, which may communicate in accordance with IEEE 802.11 communication standards, including IEEE 802.11ax. The user device(s) 120 may be mobile devices that are non-stationary and do not have fixed locations.

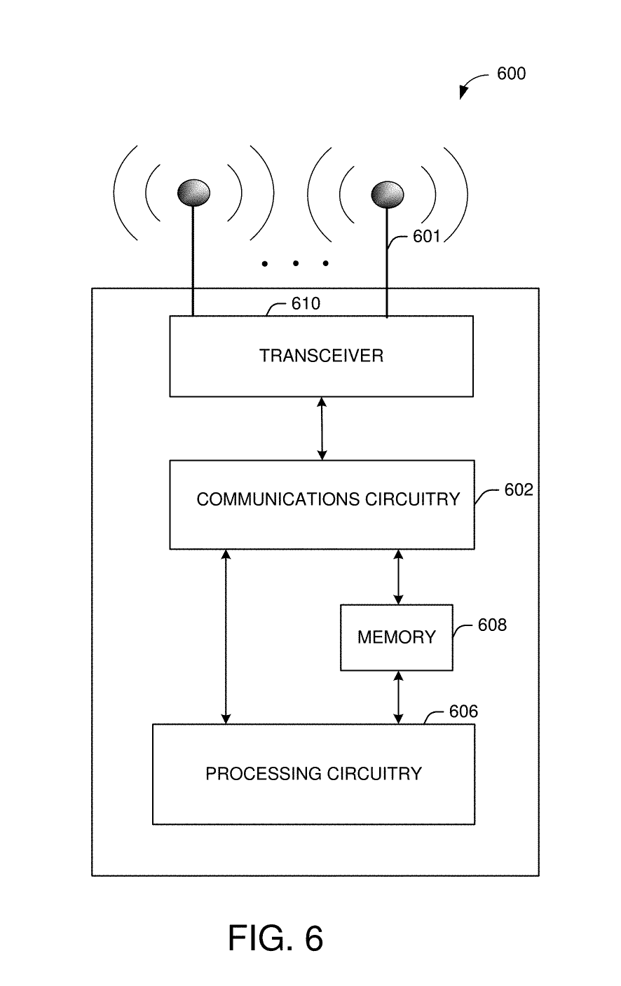

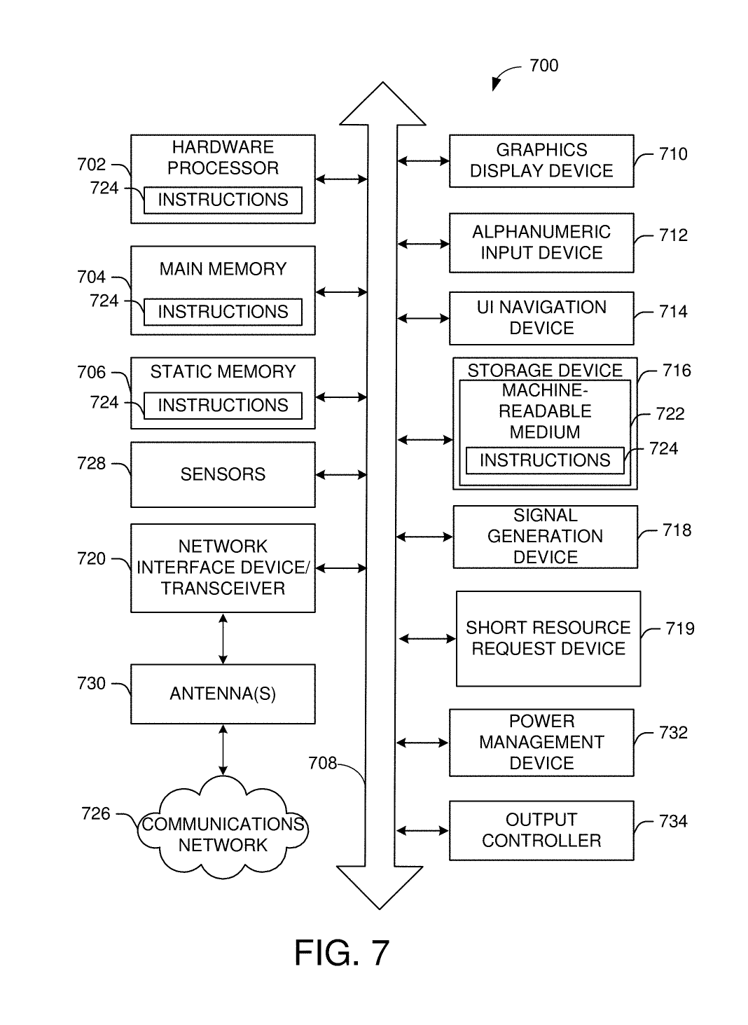

In some embodiments, the user devices 120 and the AP 102 may include one or more computer systems similar to that of the functional diagram of FIG. 6 and/or the example machine/system of FIG. 7.

One or more illustrative user device(s) 120 and/or AP 102 may be operable by one or more user(s) 110. The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. The user device(s) 120 may also communicate peer-to-peer or directly with each other with or without the AP 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124, 126, and/or 128), the AP may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and the user devices).

A user device 120 may be assigned one or more resource units or may randomly access the operating channel. It is understood that a resource unit may be bandwidth allocation on an operating channel in a time and/or frequency domain. For example, with respect to the AP assigning resource units, in a frequency band of 20 MHz, there may be a total of nine resource units, each having the size of a basic resource unit of 26 frequency tones. The AP 102 may assign one or more of these resource units to one or more user device(s) 120 to transmit their uplink data.

During data communication between a transmitting device (e.g., user device 120) and a receiving device (e.g., AP 102), the transmitting device may select the number of spatial streams that may be used for transmitting data to the receiving device.

Training fields of each data stream (also referred to as channels) are sent over orthogonal resources separable in time, frequency and code sequence domains in order to achieve the orthogonality between the training symbols. An orthogonal matrix such as the P matrix may be applied to the training symbols for a given group of user devices, which may result in training symbols being separated and easier to distinguish. An orthogonal matrix such as the P matrix may have a size of M elements by N elements. For example, interferences between the symbols may be mitigated by utilizing the orthogonality feature of the training symbols that have been converted using a P matrix.

Referring to FIG. 1, the user devices 120 and the AP 102, which may be HEW devices or legacy devices, may communicate with each other and transmit data on an operating channel. The user devices 120 may access the operating channel to transmit their data. In order to do so, the user devices 120 may access the operating channel using assigned (or scheduled) resource units.

In one embodiment, the user device 120 may request resource allocation by sending a resource request (e.g., resource request 108). The resource request may be generated by employing various embodiments of the present disclosure.

When the AP receives the resource allocation request from a user device 120, the AP (e.g., AP 102) may send a trigger frame (e.g., trigger frame 104) indicating which resource units (RUs) 106 are assigned (or in the alternative, a user device 120 may randomly select a resource unit from the trigger frame in case the user device was not assigned a resource unit by the AP 102. The resource units may be represented by RU1, RU2, . . . , RUn, where “n” is an integer. These resource units may be arranged in a sequence in the trigger frame or may be arranged randomly. These resource units may be resources in time domain, frequency domain, or a combination of time and frequency domain. The user device 120 may use one of these resource units in order to send data to an access point (e.g., AP 102).

In one embodiment, an AP 102 may assign the resource units to a user device 120 using RBIDs. In other embodiments, the AP may not assign resource units to a user device. In that case, the user device may randomly select an RBID to be associated with that user device. The AP may recognize the user device by its assigned RBID or its randomly selected RBID.

When the user device receives the trigger frame, the user device 120 may determine that one or more of the resource units are assigned to it using detection techniques, such as user ID, association ID (AID) or partial AID, RBID, or other means. The user device 120 would then be able to transmit its uplink data using the resource unit(s).

In one embodiment, a short resource request system may utilize one or more consecutive HE-LTF fields for a resource request mechanism. User devices that want to send a resource request or want to provide a YES or NO answer to an AP may code a multi-bit resource request on the multiple consecutive HE-LTF fields using their assigned and randomly selected RBIDs. For example, a user device 120 that intends to transmit one or more resource requests or intends to provide a YES or NO answer using one or more HE-LTF fields may transmit on consecutive HE-LTF fields in the time domain. For example, the user device 120 may encode its resource request or the YES or NO answer on HE-LTF fields with the same assigned RBID or with different RBIDs. For example, a user device 120 may use one HE-LTF field in order to provide a YES or NO answer such that if the symbols in the HE-LTF field are present, the AP may determine that the user device answered with a YES. Otherwise, the AP may determine that the user device answered with a NO. It is understood that the above descriptions are for purposes of illustration and are not meant to be limiting.

In another embodiment, a user device 120 may transmit its resource request on consecutive HE-LTF fields (in a time domain) having different RBIDs assigned to each corresponding HE-LTF field. For example, a user device may utilize a first RBID for a first HE-LTF field, and a second RBID for a second HE-LTF field, and so on. The AP may be aware of how the user device is encoding its bits using the HE-LTF fields. The AP may have instructed the user device to utilize the HE-LTF fields in that manner.

In one embodiment, a user device may transmit a first HE-LTF field with an assigned RBID and a second HE-LTF field on a second RBID that is spaced by a predetermined value from the assigned RBID by a certain value. For example, if the predetermined value is 3, a user device may transmit a first HE-LTF field on RBID 1 and a second HE-LTF field on RBID(1+3), which may be RBID 4. For example, a user device 120 may transmit on consecutive HE-LTF fields with an assigned RBID on the first HE-LTF field and on an RBID equal to the assigned RBID plus a delta_N value modulo (max number of RBIDs) for the Nth HE-LTF field. The delta_N value may be assigned to an Nth user device or may be included in the trigger frame. In another embodiment, the delta_N per user device is not signaled in the trigger frame. This may allow for diversity between user devices and also to ensure that the adjacent RBIDs are not using the same HE-LTF field to minimize interference. Having consecutive HE-LTF fields based on the same or varied RBIDs may increase the reliability of the reception, especially when RBIDs are from different resource units, which may avoid channel dips in frequency.

In another embodiment, a user device 120 may transmit its resource request using an HE-LTF field based on a group of devices that the user device 120 may belong to.

During communication between the user devices 120 and the AP 102, the AP 102 may use a trigger frame to initiate the resource request feedback from the user devices 120 using the HE-LTF fields. For example, the AP 102 may send the trigger frame to the user devices 120, where the trigger frame may signal the information that the AP expects from the one or more user devices receiving the trigger frame when using the HE-LTF fields. This will ensure that the AP 102 may be able to correctly decode the HE-LTF fields received from the user devices 120.

In one embodiment, a user device may transmit on consecutive HE-LTF fields that may each be associated with a group of devices. That is, a first HE-LTF field may be transmitted in time over various RUs, RBIDs, and SSs, where the first HE-LTF field may be associated with a first group of devices. Further, a second HE-LTF field may be transmitted in time over various RUs, RBIDs, and SSs, where the second HE-LTF field may be associated with a second group of devices. Although, this example uses two HE-LTF fields associated with two groups of devices, other numbers of HE-LTF fields and groups of devices may be envisioned.

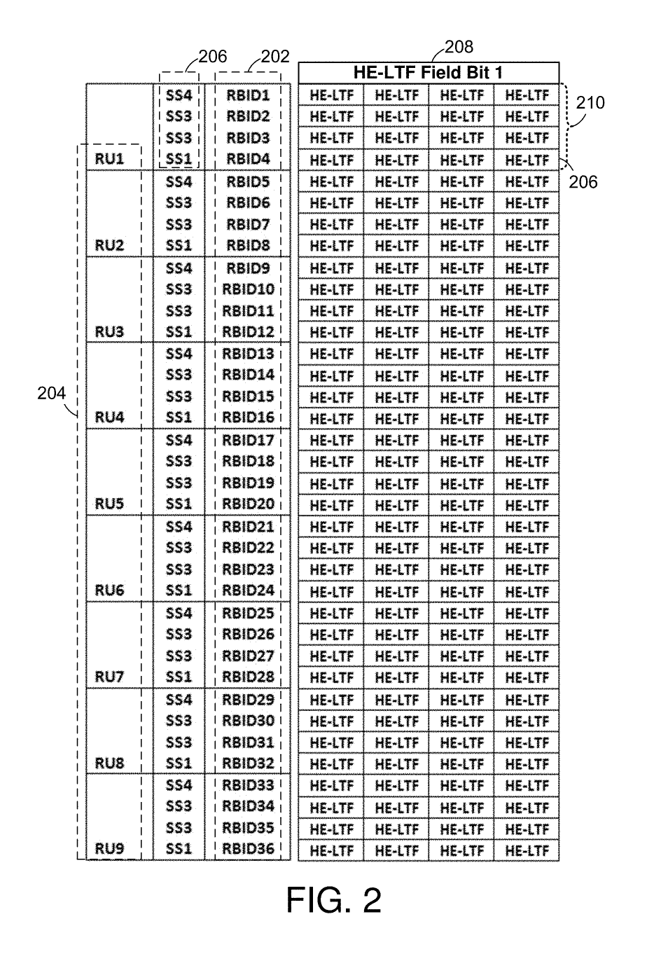

FIG. 2 depicts an illustrative schematic diagram of HE-LTF field transmission on the uplink (UL), in accordance with one or more example embodiments of the present disclosure.

In a 1-bit UL transmission model, OFDMA may be used with HE-LTF transmissions, by using resource blocks (RBs) defined by a resource unit in frequency and a spatial stream (SS) in the spatial dimension (HE-LTF multiplied by the P-matrix row corresponding to that SS). When a user device wants to transmit data, it may be assigned or it may select a resource based on an assigned RBID or a selected RBID. That is, an RBID may be associated with a user device such that the AP may assign a resource unit (RU) based on that RBID. Referring to FIG. 2, there is shown 36 resource blocks (RBs) having respective RBIDs 202 associated with nine resource units (e.g., RU 1 . . . RU 9) 204, for example, in a 20 MHz mode. Each RU may have four SSs that may be used for communication. The spatial streams may be associated with one or more antennas on the user device. Since there are four SSs, four HE-LTFs (consecutive in time) may be used in order to apply the rows of the P-matrix code. For example, in RU 1, there may be four HE-LTF fields 210 that may be transmitted on the four SSs. Each row of the HE-LTF fields 210 may be associated with a specific RBID and a spatial stream. For example, in RU 1, SS1 may be associated with RBID4, such that HE-LTF row 206 may be sent on that SS1. The HE-LTF row 206 may be utilized to enable the encoding of 1 bit of information per RBID, for up to 36 users. For example, on a particular RB, if the HE-LTFs are transmitted by transmitting energy using a row of the P matrix, the bit may be interpreted to be equal to 1 (or a YES answer) and if the HE-LTFs are not transmitted by not transmitting energy, the bit may be interpreted to be equal to 0 (or a NO answer). It is understood that the above is only an example and that any other number of RBs, RUs, and SSs may be used. Consequently, a high number of user devices may be able to transmit short 1-bit information.

On each RBID, an AP may determine whether energy is present on an RBID associated with an SS and an RU. For example, the AP may determine, based on the RBID, which user device is transmitting. If the AP determines that it received the HE-LTFs by determining that energy was transmitted on that RBID, the AP may determine how to decode that information. For example, if HE-LTFs were received, the AP may interpret that as a bit equal to 1. Based on that, the AP may determine the resource request home of that user device. The AP may collect the bits received on the different fields and may recover the resource request information. It should be understood that this information may also be used for other purposes. For example, the encoding of bits using HE-LTFs may be implemented in a PS-poll procedure, where a user device that may be in a sleep mode (powered off or in an inactive state) may solicit an immediate delivery from its AP by using a PS-poll frame. Upon receiving this PS-poll, the AP may send one or more buffered downlink frames, or it may send an acknowledgement message and response with a buffered data frame for later. Therefore, by implementing one or more consecutive HE-LTF fields, the AP and the user device may be able to encode and decode specific information that may be understood to indicate the type of procedure being utilized (e.g., resource request, PS-poll, etc.).

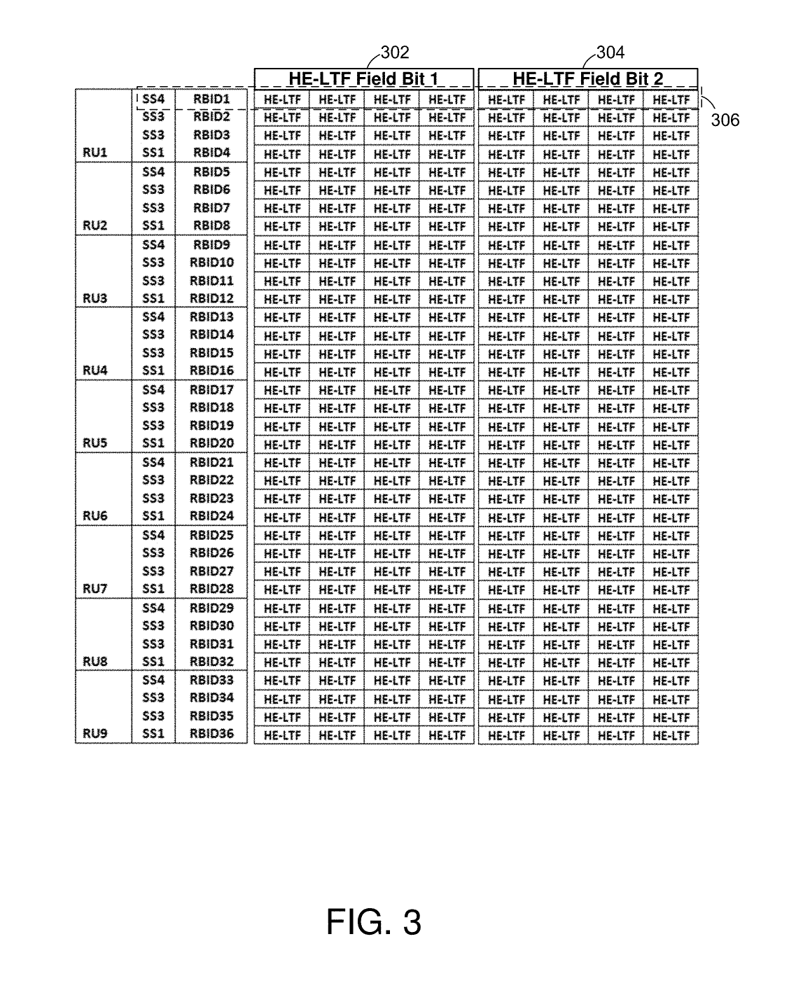

FIG. 3 depicts an illustrative schematic diagram of a short resource request system, in accordance with one or more example embodiments of the present disclosure.

In one embodiment, a time dimension may be used to enable user devices (e.g., the user devices 120 of FIG. 1) to transmit their respective bits several times to improve the detection probability on the receiving side (e.g., at an AP). Multiple HE-LTF fields, consecutive in time, may be defined with each of them corresponding to a redundant transmission. For example, if a transmission with two fields is needed, an HE-LTF field 302 and an HE-LTF field 304 may be utilized. In this example, the HE-LTF field 302 may be made of four consecutive HE-LTF symbols (e.g., four OFDM symbols), and the HE-LTF field 304 may be also made of four consecutive HE-LTF symbols.

For example, in RU 1, SS4 may be associated with RBID1, such that HE-LTF row 306 may be sent on that SS4. The HE-LTF row 306 may be utilized to enable the encoding of 2 bit of information per RBID, for up to 36 users. For example, on a particular RB, if the HE-LTFs are transmitted by transmitting energy using a row of the P matrix, each bit may be interpreted to be equal to 1 (or a YES answer) and if the HE-LTFs are not transmitted by not transmitting energy, each bit may be interpreted to be equal to 0 (or a NO answer). It is understood that the above is only an example and that any other number of RBs, RUs, and SSs may be used. Consequently, a high number of user devices may be able to transmit short 1-bit information.

In one embodiment, an AP (e.g., the AP 102 of FIG. 1) may utilize a trigger frame to initiate the resource request feedback from one or more user devices using the HE-LTFs. For example, the AP may send the trigger frame to the one or more user devices, where the trigger frame may signal the information that the AP expects from the one or more user devices receiving the trigger frame when using the HE-LTFs. The information may include, but is not limited to, parameters associated with the resource blocks (if this information was not defined in a beacon frame or in a specific control frame), where the parameters may include, at least in part, the number of spatial streams and the number of resource units. Further, the information may include the number of HE-LTF fields for redundancy purposes. For example, the information may indicate that two HE-LTF fields are to be encoded by a user device (as shown in FIG. 3). In other examples, more HE-LTF fields may be encoded by a user device. The information may also include different delta_N values (or a single delta value or a specific code, etc.) if this concept was being implemented by the AP and the user device. For example, a user device may transmit on consecutive HE-LTF fields with an assigned RBID on the first HE-LTF field, and on another RBID equal to the assigned RBID plus a delta_N value modulo (max number of RBIDs) for the Nth HE-LTF field. Having consecutive HE-LTF fields based on the same or varied RBIDs may increase the reliability of the reception, especially when the RBIDs may be from different resource units, which may avoid channel dips in frequency.

In one embodiment, on the receiving device side (e.g., on AP 102 of FIG. 1), the AP 102 may perform redundancy detection on the different HE-LTFs/RBIDs corresponding to each user allocation, or simply detect energy on every RBID of every HE-LTF field. The detection of one RBID in one HE-LTF field corresponding to the allocation of a user may be considered correct, even if the other RBIDs in different HE-LTFs corresponding to the same user allocation are not detected because of channel dips.

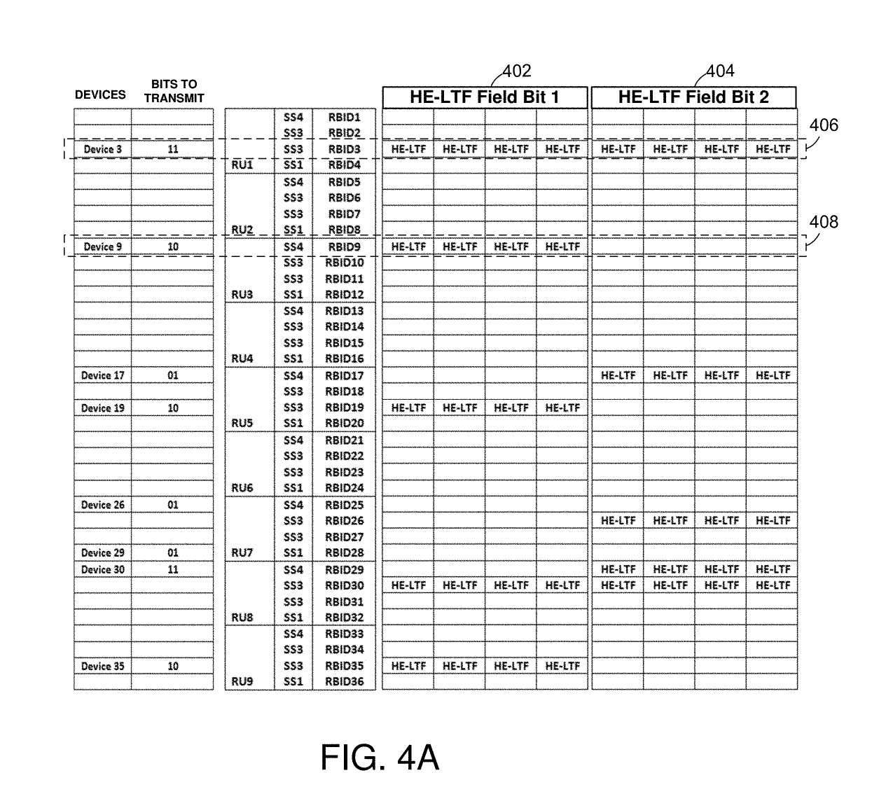

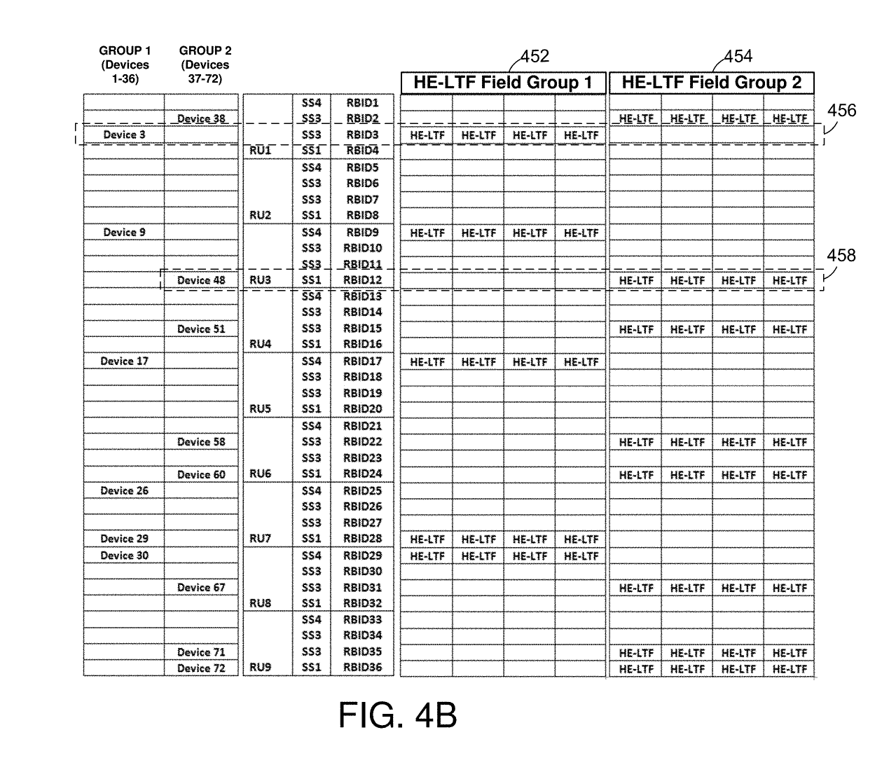

FIG. 4A depicts an illustrative schematic diagram of a short resource request system, in accordance with one or more example embodiments of the present disclosure.

In one embodiment, user devices 120 of FIG. 1 may transmit their encoded bits using multiple HE-LTF fields consecutive in time dimension in order to increase redundancy. For example, if two HE-LTF fields are used (e.g., HE-LTF field 402 and HE-LTF field 404), a user device may transmit bits to encode information associated with a resource request. When the AP (e.g., AP 102 of FIG. 1) receives energy on the various HE-LTF fields, the AP may determine that the bit is set to 1 (or a YES answer), and when no energy is received, the AP may determine that the bit is set to 0 (or a NO answer). It should be understood that although in this example two HE-LTF fields are illustrated, more than two HE-LTF fields may be utilized, for example, up to a number N of HE-LTF fields, where N is an integer.

In one embodiment, for the 2-bit example of FIG. 4A, a transmission of different 2 bits by different user devices may be received in the AP. For example, looking at row 406, there is shown a user device (e.g., user device 3) transmitting eight consecutive HE-LTF symbols constituting two HE-LTF fields (e.g., HE-LTF field 402 and HE-LTF field 404). The user device 3 may intend to transmit 11 bits in its 2-bit transmission to another device (e.g., AP 102 of FIG. 1). The AP may have assigned the user device 3 and the RBID3 using spatial stream SS3 on resource unit RU1, as shown in the example of FIG. 4A. As another illustration, looking at row 408, there is shown a user device (e.g., user device 9) which may transmit 10 bits in its 2-bit transmission by utilizing RBID9 using spatial stream SS4 on resource unit RU3. In this case, the user device 9 may transmit HE-LTF symbols in the HE-LTF field 402, but does not transmit any HE-LTF symbols in the HE-LTF field 404. When the AP receives the HE-LTF fields 402 and 404, the AP may determine whether energy is present at the designated symbols of each HE-LTF field in order to decode the 2-bit transmission by the user device 9. It is understood that the above descriptions are for purposes of illustration and are not meant to be limiting.

In one embodiment, for every multi-bit (e.g., N bits) configuration, the combination with all zeros may be considered as a non-transmission. For instance, for a 2-bit configuration, the combination 00 may not carry specific information, except from being understood as a NO answer, due to sleep (e.g., power save) or another reason. With 2 bits, three different information (e.g., 01, 11, and 10) may be encoded. Similarly, with N bits, 2^{N}−1 different information/combinations may be encoded, where N is an integer.

In one embodiment, different RBIDs may be utilized on the different HE-LTF bit fields. For example, if the RBIDs are assigned to user devices by the AP, the AP may either assign the same RBID to the same user device for all of the HE-LTF fields, or may assign different RBIDs to the same user device, e.g., one for each HE bit field (one RBID for bit 1, another RBID for bit 0).

In one embodiment, other information may also be carried with this mechanism. For example, in the case of a resource request with 2 bits, one or more requested access categories may be carried, e.g., management frame, access category video (AC-VI), access category best effort (AC-BE), access category voice (AC-VO), access category background (AC-BK), etc. In another embodiment, this mechanism may be used for a different purpose other than a resource request mechanism. For example, it may be used to signal a simple PS-poll in order to request the delivery of a packet. It is understood that the above descriptions are for purposes of illustration and are not meant to be limiting.

FIG. 4B depicts an illustrative schematic diagram of a short resource request system, in accordance with one or more example embodiments of the present disclosure.

Referring to FIG. 4B, there is a short resource request mechanism such that user devices 1-72 use HE-LTF field 452 and HE-LTF field 454 to encode a bit of information. The bit may be set based on whether HE-LTF symbols are present or not in the HE-LTF fields. That is if a user device wants to encode a 1, the user device may send energy on the four HE-LTF symbols in the HE-LTF field that is assigned to it based on the group number. That is if a user is determined to be part of Group 1, the user device may use HE-LTF field 452 in order to set the bit. However, if a user device is determined to be part of Group 2, the user device may use the HE-LTF field 454 in order to set its bit. Further, FIG. 4B depicts multiple RUs (e.g., RU1 . . . RU9), where each RU has four RBIDs and four spatial streams (e.g., SS1 . . . SS4). These RUs may be used by the user devices that have uplink data to send to the AP. In this example, a transmission for two groups of devices (Group 1 and Group 2) is implemented using two consecutive HE-LTF fields (e.g., HE-LTF field 452 and HE-LTF field 454).

In one embodiment, an AP (e.g., AP 102 of FIG. 1) may send a trigger frame to initiate the resource request feedback from one or more user devices (e.g., user devices 120 of FIG. 1) using HE-LTF fields. The trigger frame may contain information that will assist the user devices receiving the trigger frame to determine how to encode the HE-LTF fields when requesting services such as a resource request from the AP. For example, the trigger frame may contain the RBID associated with a user device and a group of devices that the user device is assigned to. When a user device receives the trigger frame, the user device may decode the fields included in the trigger frame. The user device may determine how to use the HE-LTFs based on information contained in the trigger frame. Further, the user device may determine which group of devices the AP assigned it to. For example, a user device may determine that the HE-LTF fields are to be used to encode a bit based on the RBID assigned to the user device, and the user device may determine that it belongs to the first group of users. In the example of FIG. 4B, the Group 1 of devices may include devices 1-36 and the Group 2 of devices may include devices 37-72. The designation of the device may be determined during the negotiation between the AP and the user device. This designation may also be determined at other times, for example, through the trigger frame. Further, the AP may define that each HE-LTF field consecutive in time may correspond to a group of devices. It should be understood that other requests may use any of the embodiments discussed in the present disclosure. For example, the HE-LTF fields may be used for PS-poll, or any other messaging mechanisms.

Looking at row 456 in FIG. 4B, a user device 3 may have been assigned to Group 1, using HE-LTF field 452. Further, user device 3 may be assigned to RU1 and RBID3 using spatial stream SS3. In that case, whenever user device 3 wants to encode a bit of information that may be used for resource requests, the user device 3 may use HE-LTF field 452 by sending HE-LTF symbols in order to indicate a value of 1 and not sending HE-LTF symbols in order to indicate a value of 0. Similarly, looking at row 458, a user device 48 may have been assigned to Group 2, using HE-LTF field 454. Further, user device 48 may be assigned to RU3 and RBID12 using spatial stream SS1. In that case, whenever user device 48 wants to encode a bit of information that may be used for resource requests, the user device 3 may use HE-LTF field 454 by sending HE-LTF symbols in order to indicate a value of 1 and not sending HE-LTF symbols in order to indicate a value of 0. It is understood that the above descriptions are for purposes of illustration and are not meant to be limiting.

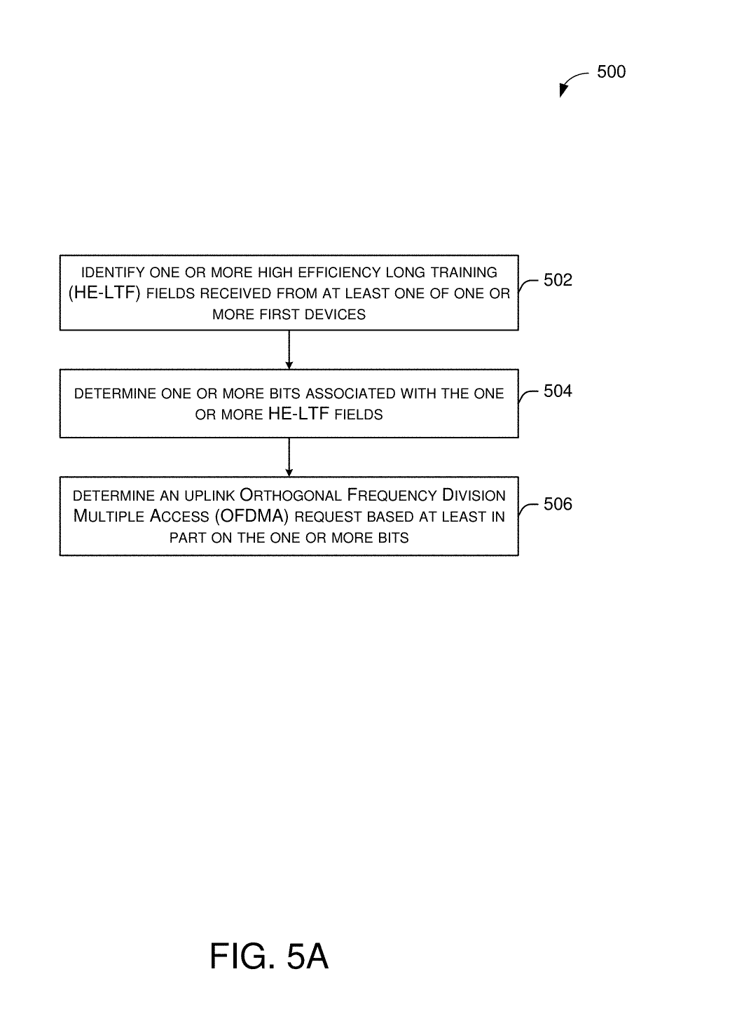

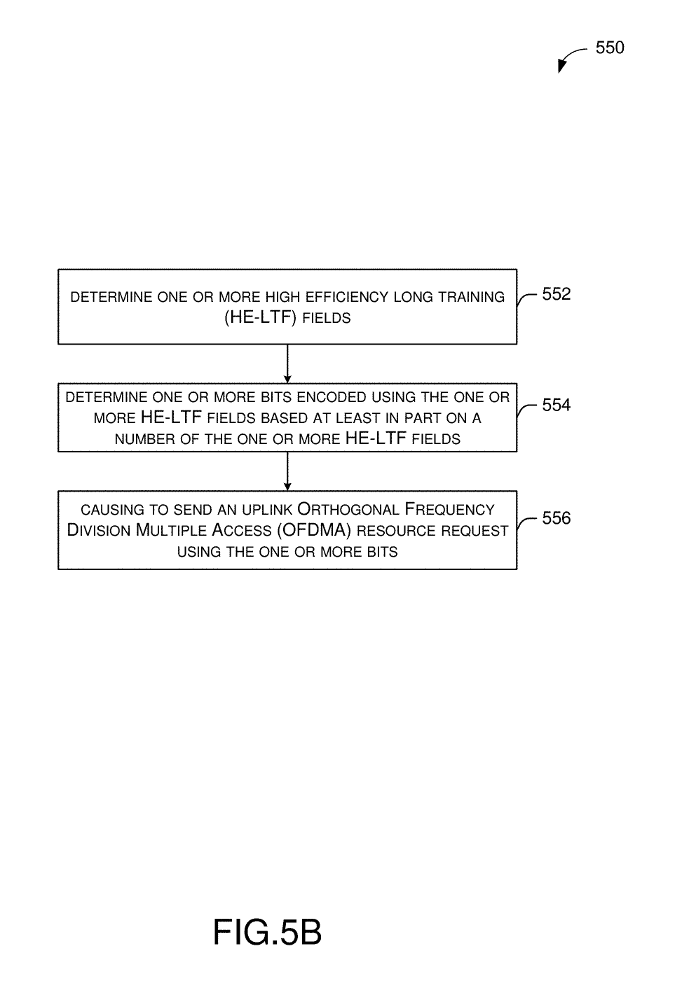

FIG. 5A illustrates a flow diagram of an illustrative process 500 for a short resource request system, in accordance with one or more embodiments of the disclosure.

At block 502, a device (e.g., the user device(s) 120 and/or the AP 102 of FIG. 1) may identify one or more high efficiency long training (HE-LTF) fields received from at least one of one or more user devices. For example, the user devices that want to send a resource request to an AP may code their multi-bit resource requests on the multiple consecutive HE-LTF fields using their assigned and randomly selected resource block IDs (RBIDs). An AP may assign an RBID to a user device at the time the user device associates or communicates with the AP. For example, in order to code a bit equal to 1 on a specific slot, the user device may transmit the HE-LTF using its RBID. That is, the user device may utilize the RBID assigned to it in order to use a spatial stream for transmitting the HE-LTF field in order to indicate that a code bit is equal to 1. To code a bit equal to 0 on a specific slot, the user device may not transmit anything. That is, the spatial stream associated with the user device's RBID may be left empty in order to indicate a code bit equal to 0. On each RBID, the AP will collect the bits received on the different fields and will determine the resource request information. The user devices may send their coded resource requests using HE-LTF fields that may be received by the AP.

At block 504, the AP may determine one or more bits associated with the one or more HE-LTF fields. That is, the AP may be able to determine based on receiving the HE-LTF fields whether a bit is set to 1 or 0 (or to a YES or NO answer). As explained above, an HE-LTF field may contain one or more HE-LTF symbols. The AP may determine any HE-LTF symbols based on determining whether energy exists from the signals received based on the HE-LTF symbols. If the AP determines that energy does exist, that is the HE-LTF symbol is received, the AP may determine that an HE-LTF field is set to 1 (or a YES answer). Otherwise, if the AP does not determine that energy exists from the signals received based on the HE-LTF symbols, the AP may determine that an HE-LTF field is set to 0 (or a NO answer).

At block 506, the AP may determine an uplink orthogonal frequency division multiple access (OFDMA) request based at least in part on the one or more bits. For example, one or more consecutive HE-LTF fields may be encoded in order to indicate an uplink resource request. User devices that want to send a resource request to an AP may code a multi-bit resource request on multiple consecutive HE-LTF fields using their assigned and randomly selected RBIDs. For example, a user device that intends to transmit one or more resource requests using one or more HE-LTF fields may transmit on consecutive HE-LTF fields in the time domain. For example, the user device may encode its resource request on HE-LTF fields with the same assigned RBID or with different RBIDs. It is understood that the above descriptions are for purposes of illustration and are not meant to be limiting.

FIG. 5B illustrates a flow diagram of an illustrative process 550 for a short resource request system, in accordance with one or more example embodiments of the present disclosure.

At block 552, a device (e.g., the user device(s) 120 and/or the AP 102 of FIG. 1) may determine one or more high efficiency long training (HE-LTF) fields. For example, an AP may receive one or more HE-LTF fields that may be used to determine a request from a user device. For example, a user device 120 that intends to transmit one or more resource requests using one or more HE-LTF fields may transmit on consecutive HE-LTF fields in the time domain. For example, the user device may encode its resource request on HE-LTF fields with the same assigned RBID or with different RBIDs. It is understood that the above descriptions are for purposes of illustration and are not meant to be limiting.

At block 554, the device may determine one or more bits encoded using the one or more HE-LTF fields based at least in part on a number of the one or more HE-LTF fields. For example, a user device may intend to transmit a resource request using two HE-LTF fields that may be consecutive in the time domain. The user device may encode bits using the two HE-LTF fields.

At block 556, the device may cause to send an uplink orthogonal frequency division multiple access (OFDMA) resource request using the one or more bits. For example, one or more consecutive HE-LTF fields may be encoded in order to indicate an uplink resource request. User devices that want to send a resource request to an AP may code a multi-bit resource request on multiple consecutive HE-LTF fields using their assigned and randomly selected RBIDs. For example, a user device that intends to transmit one or more resource requests using one or more HE-LTF fields may transmit on consecutive HE-LTF fields in the time domain. For example, the user device may encode its resource request on HE-LTF fields with the same assigned RBID or with different RBIDs. For example, if two HE-LTF fields are used to code a resource request, the AP may determine that the first HE-LTF field may be assigned a first RBID, and the second HE-LTF field may be assigned a second RBID. In that case, the user device that intends to code the resource request on the two HE-LTF fields may code a first bit on the first HE-LTF using the first RBID and may code a second bit on the second HE-LTF using the second RBID.

In another example, a user device may transmit on consecutive HE-LTF fields that may each be associated with a group of devices. That is, a first HE-LTF field may be transmitted in time over various RUs, RBIDs, and SSs, where the first HE-LTF field may be associated with devices 1-36, in the case of nine RUs. Further, a second HE-LTF field may be transmitted in time over various RUs, RBIDs, and SSs, where the second HE-LTF field may be associated with devices 37-72. Although, this example uses nine RUs and 72 devices, other numbers of RUs and devices may be utilized based on the communication channel frequency bandwidth being used.

It is understood that the above descriptions are for purposes of illustration and are not meant to be limiting.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2, 3, 4A, 4B, 5A, and 5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a short resource request device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The short resource request device 719 may carry out or perform any of the operations and processes (e.g., processes 500 and 550) described and shown above. For example, the short resource request device 719 may be configured to send a request (e.g., a resource request) to an AP by coding a multi-bit request on multiple consecutive HE-LTF fields using assigned or randomly selected resource block IDs (RBIDs). An AP may assign an RBID to a user device at the time the user device associates or communicates with the AP. For example, in order to code a bit equal to 1 on a specific slot, the user device may transmit the HE-LTF using its RBID. That is, the user device may utilize the RBID assigned to it in order to use a spatial stream for transmitting the HE-LTF field in order to indicate that a code bit is equal to 1 (or a YES answer). To code a bit equal to 0 (or a NO answer) on a specific slot, the user device may not transmit anything. That is, the spatial stream associated with the user device's RBID may be left empty in order to indicate a code bit equal to 0 (or a NO answer). On each RBID, the AP will collect the bits received on the different fields and will determine the resource request information.

The short resource request device 719 may utilize a time dimension aspect such that one or more consecutive HE-LTF fields may be used for a resource request mechanism. User devices that want to send a resource request to an AP may code their multi-bit resource requests on multiple consecutive HE-LTF fields using their assigned and randomly selected resource block IDs (RBIDs). A user device that intends to transmit one or more resource requests a using high efficiency long training (HE-LTF) field may transmit on consecutive HE-LTF fields in the time domain. For example, a user device may transmit an HE-LTF with the same assigned RBID.

The short resource request device 719 may be configured to transmit on consecutive HE-LTF fields having different RBIDs assigned to the corresponding HE-LTF fields.

The short resource request device 719 may be configured to transmit on consecutive HE-LTF fields with the assigned RBID on the first HE-LTF field and on the RBID equal to the assigned RBID plus a delta_N value modulo (max number of RBIDs) for the Nth HE-LTF field. Having consecutive HE-LTF fields based on the same or varied RBIDs may increase the reliability of the reception, especially when the RBIDs may be from different resource units, which may avoid channel dips in frequency.

The short resource request device 719 may be configured to transmit on consecutive HE-LTF fields that may each be associated with a group of devices. That is, a first HE-LTF field may be transmitted in time over various RUs, RBIDs, and SSs, where the first HE-LTF field may be associated with devices 1-36, in the case of nine RUs. Further, a second HE-LTF field may be transmitted in time over various RUs, RBIDs, and SSs, where the second HE-LTF field may be associated with devices 37-72. Although, this example uses nine RUs and 72 devices, other numbers of RUs and devices may be utilized based on the communication channel frequency bandwidth being used.

It is understood that the above are only a subset of what the short resource request device 719 may be configured to perform and that other functions included throughout this disclosure may also be performed by the short resource request device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 500 and 550) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include at least one memory that stores computer-executable instructions; and at least one processor of the one or more processors configured to access the at least one memory, wherein the at least one processor of the one or more processors is configured to execute the computer-executable instructions to: identify one or more high efficiency long training (HE-LTF) fields received from at least one of one or more first devices; determine one or more bits associated with the one or more HE-LTF fields; and determine an uplink orthogonal frequency division multiple access (OFDMA) request based at least in part on the one or more bits.

The implementations may include one or more of the following features. The one or more HE-LTF fields include at least in part one or more HE-LTF symbols. The one or more HE-LTF fields are sent consecutively in at least one of a time domain or a frequency domain. The one or more bits include a first bit associated with a first HE-LTF field and a second bit associated with a second HE-LTF field. The first HE-LTF field is associated with a first group of devices and the second HE-LTF field is associated with a second group of devices. The first HE-LTF field is associated with a first resource block ID (RBID) and the second HE-LTF field is associated with a second RBID. The at least one processor may be further configured to execute the computer-executable instructions to cause to send to one or more devices, a first trigger frame comprising one or more resource blocks. The first bit is associated with a first resource unit, a spatial stream, and an RBID associated with the at least one of the one or more first devices. The device may further include a transceiver configured to transmit and receive wireless signals. The device of claim 9, further comprising one or more antennas coupled to the transceiver.

According to example embodiments of the disclosure, there may be a non-transitory computer-readable medium storing computer-executable instructions which, when executed by a processor, cause the processor to perform operations. The operations may include determining one or more high efficiency long training (HE-LTF) fields; determining one or more bits encoded using the one or more HE-LTF fields based at least in part on a number of the one or more HE-LTF fields; and causing to send an uplink orthogonal frequency division multiple access (OFDMA) resource request using the one or more bits.

The implementations may include one or more of the following features. The one or more HE-LTF fields are sent consecutively. The one or more bits include a first bit associated with a first HE-LTF field and a second bit associated with a second HE-LTF field. The first HE-LTF field is associated with a first resource block ID (RBID) and the second HE-LTF field is associated with a second RBID. The first bit is associated with a first resource unit, a spatial stream, and an RBID.

In example embodiments of the disclosure, there may be an apparatus. The apparatus may include means for identifying one or more high efficiency long training (HE-LTF) fields received from at least one of one or more first devices. The apparatus may include means for determining one or more bits associated with the one or more HE-LTF fields. The apparatus may include means for determining an uplink orthogonal frequency division multiple access (OFDMA) request based at least in part on the one or more bits.

The implementations may include one or more of the following features. The one or more HE-LTF fields include at least in part one or more HE-LTF symbols. The one or more HE-LTF fields are sent consecutively in at least one of a time domain or a frequency domain. The apparatus of claim 34, wherein the one or more bits include a first bit associated with a first HE-LTF field and a second bit associated with a second HE-LTF field. The first HE-LTF field is associated with a first group of devices and the second HE-LTF field is associated with a second group of devices. The first HE-LTF field is associated with a first resource block ID (RBID) and the second HE-LTF field is associated with a second RBID. The apparatus may further include means for causing to send to one or more devices, a first trigger frame comprising one or more resource blocks. The first bit is associated with a first resource unit, a spatial stream, and an RBID associated with the at least one of the one or more first devices.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-24. (canceled)

25. A device, comprising:
at least one memory that stores computer-executable instructions; and
at least one processor of the one or more processors configured to access the at least one memory, wherein the at least one processor of the one or more processors is configured to execute the computer-executable instructions to:
identify one or more high efficiency long training (HE-LTF) fields received from at least one of one or more first devices;
determine one or more bits associated with the one or more HE-LTF fields; and
determine an uplink Orthogonal Frequency Division Multiple Access (OFDMA) request based at least in part on the one or more bits.

26. The device of claim 25, wherein the one or more HE-LTF fields include at least in part one or more HE-LTF symbols.

27. The device of claim 25, wherein the one or more HE-LTF fields are sent consecutively in at least one of a time domain or a frequency domain.

28. The device of claim 25, wherein the one or more bits include a first bit associated with a first HE-LTF field and a second bit associated with a second HE-LTF field.

29. The device of claim 28, wherein the first HE-LTF field is associated with a first group of devices and the second HE-LTF field is associated with a second group of user devices.

30. The device of claim 28, wherein the first HE-LTF field is associated with a first RBID and the second HE-LTF field is associated with a second RBID.

31. The device of claim 28, wherein the at least one processor is further configured to execute the computer-executable instructions to cause to send to one or more user devices, a first trigger frame comprising one or more resource blocks.

32. The device of claim 28, wherein the first bit is associated with a first resource unit, a spatial stream, and an RBID associated with the at least one of the one or more first devices.

33. The device of claim 25, further comprising a transceiver configured to transmit and receive wireless signals.

34. The device of claim 33, further comprising one or more antennas coupled to the transceiver.

35. A non-transitory computer-readable medium storing computer-executable instructions which, when executed by a processor, cause the processor to perform operations comprising:
determine one or more high efficiency long training (HE-LTF) fields;
determine one or more bits encoded using the one or more HE-LTF fields based at least in part on a number of the one or more HE-LTF fields; and
causing to send an uplink Orthogonal Frequency Division Multiple Access (OFDMA) resource request using the one or more bits.

36. The non-transitory computer-readable medium of claim 35, wherein the one or more HE-LTF fields are sent consecutively.

37. The non-transitory computer-readable medium of claim 35, wherein the one or more bits include a first bit associated with a first HE-LTF field and a second bit associated with a second HE-LTF field.

38. The non-transitory computer-readable medium of claim 37, wherein the first HE-LTF field is associated with a first RBID and the second HE-LTF field is associated with a second RBID.

39. The non-transitory computer-readable medium of claim 37, wherein the first bit is associated with a first resource unit, a spatial stream, and an RBID.

40. A method comprising:
identifying one or more high efficiency long training (HE-LTF) fields received from at least one of one or more first devices;
determining one or more bits associated with the one or more HE-LTF fields; and
determining an uplink Orthogonal Frequency Division Multiple Access (OFDMA) request based at least in part on the one or more bits.

41. The method of claim 40, wherein the one or more HE-LTF fields include at least in part one or more HE-LTF symbols.

42. The method of claim 40, wherein the one or more bits include a first bit associated with a first HE-LTF field and a second bit associated with a second HE-LTF field.

43. The method of claim 42, wherein the first HE-LTF field is associated with a first group of devices and the second HE-LTF field is associated with a second group of user devices.

44. The method of claim 42, wherein the first HE-LTF field is associated with a first RBID and the second HE-LTF field is associated with a second RBID.
